(19) United States
(12) Patent Application Publication
(10) Pub. No.: US 2015/0154645 A1
(43) Pub. Date: Jun. 4, 2015

(54) Unknown

(71) Applicant: Paolo Zandonella Necca, Milan (IT)

(72) Inventor: Paolo Zandonella Necca, Milan (IT)

(21) Appl. No.: 14/096,923

(22) Filed: Dec. 4, 2013

(51) Int. Cl. G06Q 30/02; G06Q 50/00

(52) U.S. Cl. CPC G06Q 30/0269; G06Q 50/01

(57) ABSTRACT

A method suitable for urging via a specific social network in the Internet at least one subject willing to fulfill a given not-binding specific request of purchase for a product of interest (product request) at at least one specific maximum economical condition (maximum economical condition) made by at least one logged-in user of a specially provided social network, where (a) a logged-in user asks the administrator of said social network to create a specially provided product request page (product request page) and to add his/her maximum economical condition, having met the publication conditions set by the social network administrator according to a pre-determined table (publication conditions) and (b) the administrator of the social network publishes the product request page in the Internet.

### STATE OF THE ART

The products and/or services, shortly referred to as “products” hereafter, offered on sale are displayed and/or described in their respective exhibition areas of the points of sale along with their prices determined by the seller. Likewise, the seller puts in the Internet the products offered on sale and their respective prices in the case of the e-commerce.

Therefore, a potential buyer is obliged to search for the products of interest to him/her and their respective prices, if any, capable of meeting his/her needs in the various points of sale and/or in the Internet.

A drawback of such search is in that it obliges the buyer to physically or virtually move and to undergo the risks resulting from such displacements. Consider, for instance, the risks associated with moving in the traffic or the risks associated with the infections from computer viruses present in the network.

In a market where the same products are sold at different prices or in the case that the desired products are not available in points of sale easily accessible to the buyers, the waste of physical time, and economical energies is all the same an unpleasant drawback.

The purpose of the present invention is to overcome said drawbacks to identify a method in which the buyers are the actors of the market and request the products of their interest at prices acceptable by them. Note that the products might be either products already existing on the market or even products not available yet. In the latter case, the requests made by buyers of products not available yet might also constitute an interesting incentive for the production companies to fulfill such needs.

### DESCRIPTION OF THE INVENTION

In order to solve the problems present in the traditional market, the present invention identifies a specific solution to radically reduce, up to almost zeroing, the costs and the charges the buyer shall undergo in the traditional market.

According to the present invention, the potential buyer is a user logged in a specific Social Network, shortly a “logged-in user”. The Social Network makes it public: (i) the interest by one or several logged-in users in one or several specific products (“products of interest”); (ii) the economical conditions chosen by said users for the purchase of each of the products of interest. This way, it is possible for said logged-in users not to be obliged to search for the products of interest and/or the economical conditions of interest in the physical market and/or in the virtual market in the network.

Just as an example and in order to make the following description easier, we shall call each of said subjects: “purchase-proposing subject”. Note that a purchase-proposing subject is not bound to purchase the product by virtue of the fact that he/she made that proposal of purchase. Said not-binding proposal of purchase is displayed in the Social Network's site and is a spur addressed to the market in order for it to be met. In order to make the following description easier, we shall call said not-binding proposal of purchase: “product request”.

An outstanding advantage of the present invention is, amongst others, in that it is suitable for providing an indication about the proneness of the purchase-proposing subjects to confirm their proposal of purchase.

Note that in the traditional market the products or the services are displayed and/or described in the exhibition areas reserved therefor together with their prices determined by the seller to appeal the buyers.

The present invention modifies the conditions of the meeting between a potential buyer and a potential seller.

The present invention is one of the possible solutions to reverse the conditions that are prodromic to a sale, called “reverse market”.

The present invention is implemented by means of a method suitable for urging and attracting, through a specific social network in the Internet, at least one subject willing to fulfill a given not-binding specific proposal of purchase, “product request”, made by a purchase-proposing subject logged in said social network concerning a specific product at a specific maximum economical condition.

To make the description simpler, we shall use the term “product of interest” to indicate the product that is the object of the product request made by a purchase-proposing subject.

Also note that the purchase-proposing subject will indicate his/her maximum economical condition for the purchase of the product of interest the mentioned subject proposes to purchase. According to this method, a user who previously logged in the specific social network asks the administrator of said social network to create a specially provided page for requesting a specific product (“product request page”) in order to urge and attract a subject willing to fulfill that product request. The logged-in user will also ask the administrator to add, in the mentioned product request page, possibly with a representation of said product, his/her maximum economical condition at which he/she is interested to buy that specific product. Said page will be referred to below as “product request page”.

Just as a non-exhaustive example of what said above, let us assume that the product request is a computer Apple® model MacBook® at a maximum economical condition of purchase equal to $800.

In this example, the product request page will concern said computer Apple® with a graphical reproduction of said computer at the maximum economical condition of $800.

However, the logged-in user shall comply with given conditions set by the administrator to have his/her product request page, including his/her not-binding proposal of purchase (“product request”), published in the social network. These conditions, referred to below as “publication conditions”, shall be predetermined in a specially provided table by the social network administrator. Said conditions might be, for instance, sums of money.

All above mentioned conditions having been met, the social network administrator shall publish the product request page.

As mentioned above, the purchase-proposing subject indicated in his/her product request page his/her maximum economical condition to purchase that specific product. The maximum economical condition is preferably identified on the basis of a table determined by the social network administrator or alternatively by the first logged-in user who asked to publish the product request page. It is evident that the table determined by said logged-in user shall be valid until the product request page is present in the social network and it shall lose its validity on the basis of specific conditions set by the method or by the social network administrator.

The method according to the present invention also supports the subscription of other logged-in users to a product request page already published in the social network.

A logged-in user who desires to proceed to said subscription shall also agree with the publication conditions indicated above, whereby he/she can update a product request page automatically, according to one of the following options:

(a) by subscribing to the product request page at the maximum economical condition already present in said product request page or, alternatively;

(b) by subscribing to the product request page already present, but inserting a different maximum economical condition or, alternatively;

(c) by subscribing to the product request page at one of the maximum economical conditions already present in said product request page.

According to an experimental test made, it has been possible to ascertain that a subject willing to fulfill a given specific purchase request is interested to know the total number of subjects who have interest in a given product and the economical conditions at which said purchase will possibly take place.

Such innovative and advantageous feature is suitable for supplying the potential subjects willing to fulfill a given specific product request with the possible number of sales on the basis of a given price.

Therefore, the method according to the present invention supports the update of every product request page published in the social network, which displays the graphical representation of the total number of product requests for every maximum economical condition present because of the requests made by at least one logged-in user.

It has also been estimated that the circumstance whereby there are potential buyers of given products at given maximum economical conditions resulted not to be sufficient to appeal subjects willing to fulfill the specific product requests.

In order to overcome this drawback, according to the method of the present invention in every product request page there is a graphical representation of the minimum quantity of expected purchases for the represented product for every maximum economical condition present in said product request page.

A variety of methods are known to identify the mentioned minimum quantity of expected purchases. It has been experimentally noted that the indication of the graphical representation of the mentioned minimum quantity of expected purchases constitutes by itself an attractive element to urge and appeal subjects willing to fulfill purchasing requests for specific products.

Therefore, reliability and accuracy in identifying the mentioned minimum quantity of expected purchases for every maximum economical condition present in every product request page is an innovative and very advantageous element.

The preferred determination to identify the minimum quantity of expected purchases for a product of a product request page for every maximum economical condition is implemented through the execution of the following steps:

(a) calculating and recording the number of product requests that were followed (confirmed) by actual purchases for every previously logged-in user, shortly “number of individual confirmations”. Said number of individual confirmations is calculated and recorded according to the specific parameters set by the social network administrator;

(b) calculating and recording the number of product requests that were not previously followed (confirmed) by actual purchases for every logged-in user, shortly “number of individual denials”. Said number of individual denials is calculated and recorded according to the specific parameters set by the social network administrator;

(c) calculating and recording the estimated probability that every logged-in user confirms a generic product request, shortly “individual reliability”, on the basis of the number of individual confirmations and the number of individual denials of every logged-in user. Said estimate is preferably made on the basis of the logistic regression model;

(d) composing a cumulative probability on the basis of the individual reliabilities of those logged-in users who formed the total number of product requests for every maximum economical condition of every product request page.

According to the method, the individual reliability of every logged-in user, calculated on the basis of what described above, constitutes a condition that affects the publication conditions to be applied to every logged-in user and said conditions are considered in the table pre-determined by the social network administrator for the publication of the product request page.

Just as non-exhaustive example, if the publication conditions specify that a sum of money shall be paid by a logged-in user, then the sum of money requested by the social network administrator for the publication of a product request in a product request page is inversely proportional to the increase of individual reliability of every logged-in user.

### DESCRIPTION OF THE FIGURES

The purposes and advantages are better highlighted in the attached figures which describe, in the form of a non-exhaustive example, the method suitable for urging via a specific social network in the Internet at least one subject willing to fulfill a given not-binding specific proposal of purchase (product request) for a specific product (product of interest) at at least one specific maximum economical condition (maximum economical condition) made by at least one logged-in user of a specially provided social network.

FIG. 1 schematically shows a flow chart relevant to the method according to the invention with respect to the creation of a product request page concerning a product of interest for a user of the social network and to the update of the product request page by other logged-in users.

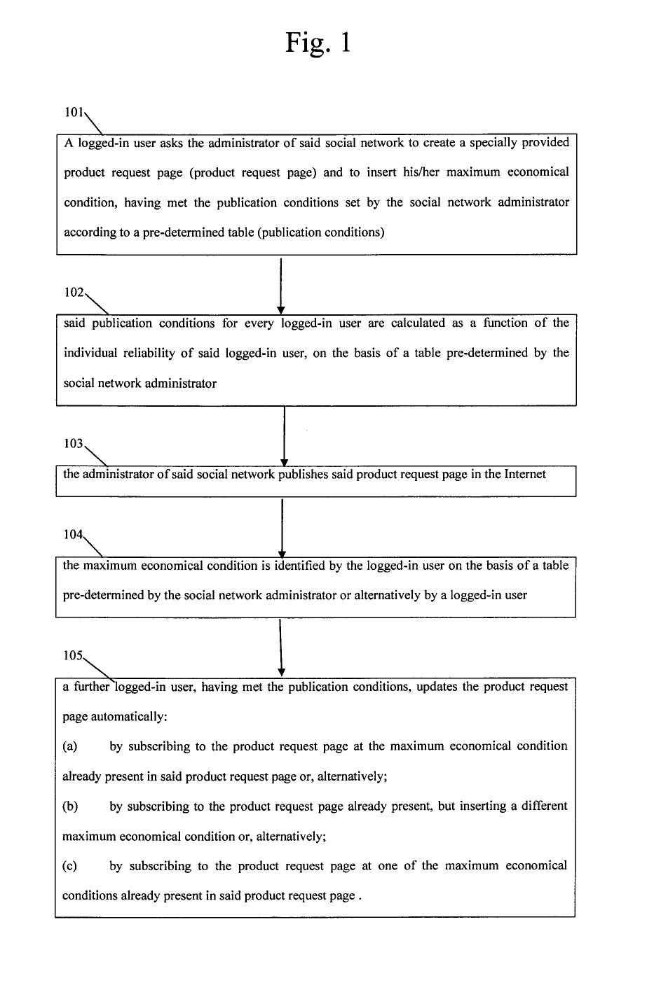

FIG. 2 schematically shows a flow chart relevant to the method according to the invention with respect to the automatic update of the graphical representation of the product request page.

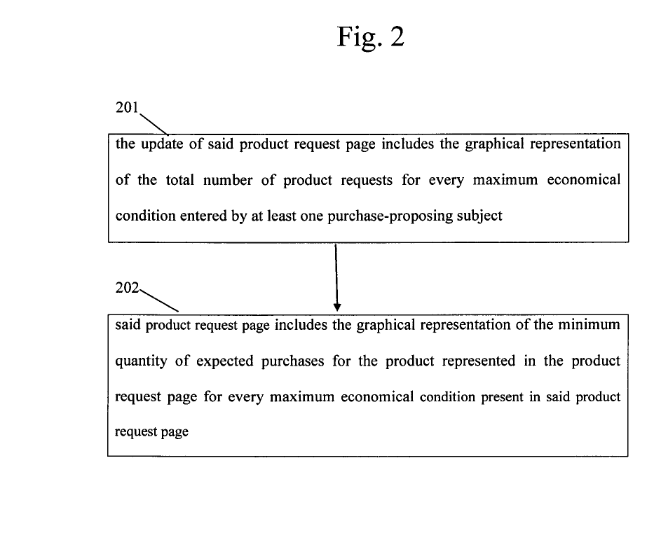

FIG. 3 schematically shows a flow chart relevant to the method according to the invention, with respect to the method used to determine the minimum quantity of expected purchases for a given product for every maximum economical condition present in the product request page. These minimum quantities of expected purchases are graphically represented in the product request page.

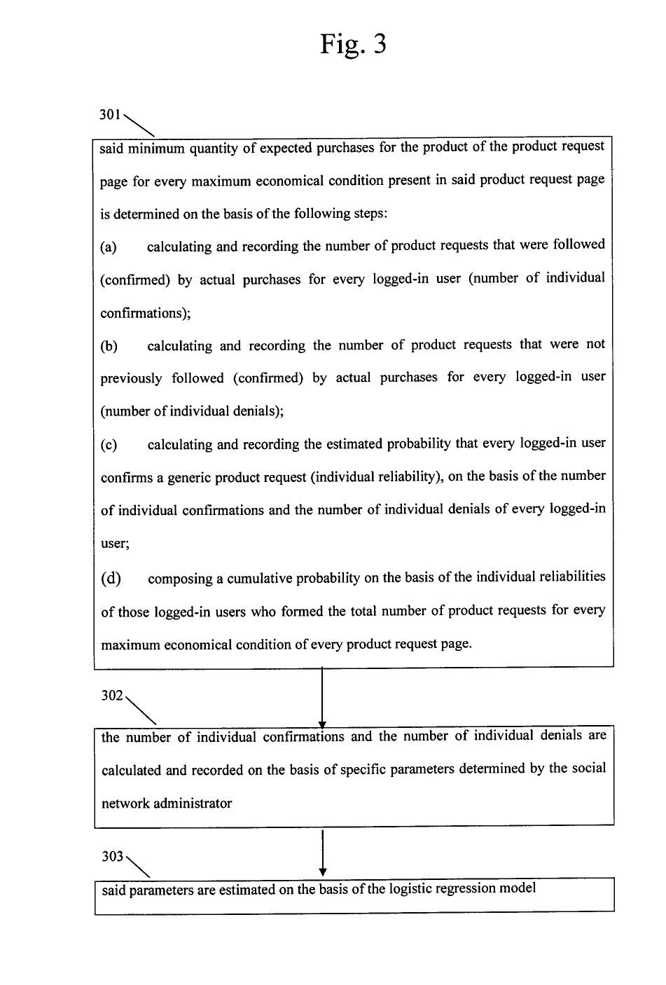

FIG. 4 shows an example of product request page referred to a product of interest which is, in the example considered in said figure, a portable computer MacBook® 15 by Apple®. For the sake of completeness, the applicant emphasizes that any references to the singular of the words of the present document, if applicable, shall also include the plural, and vice-versa.

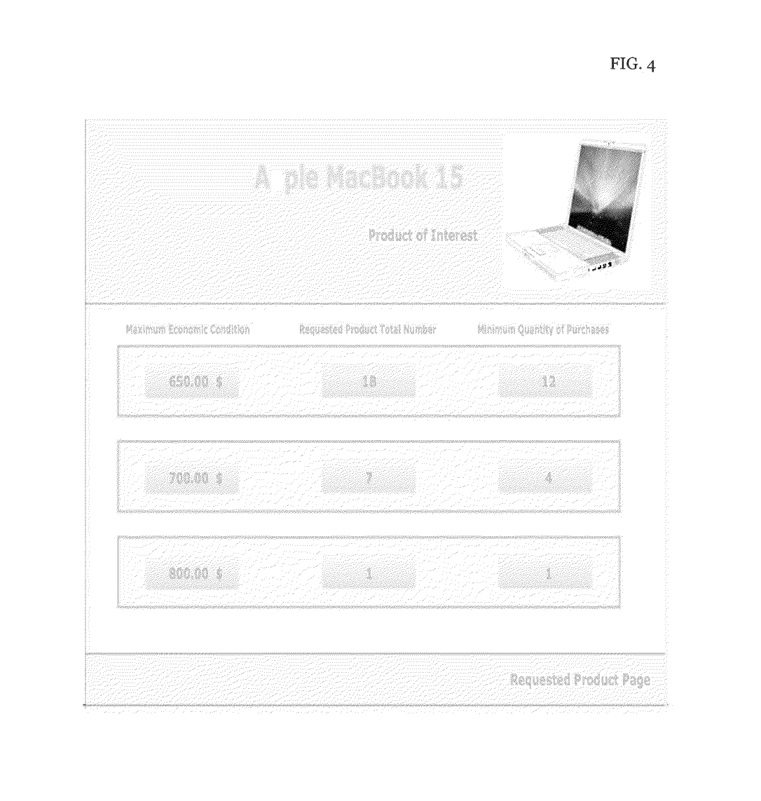

1. A method suitable for urging via a specific social network in the Internet at least one subject willing to fulfill a given not-binding specific request of purchase for a product of interest (product request) at at least one specific maximum economical condition (maximum economical condition) made by at least one logged-in user of a specially provided social network, where:
(a) a logged-in user asks the administrator of said social network to create a specially provided product request page (product request page) and to add his/her maximum economical condition, having met the publication conditions set by the social network administrator according to a pre-determined table (publication conditions);
(b) the administrator of said social network publishes said product request page in the Internet.

2. A method according to claim 1, where the maximum economical condition is identified by the logged-in user on the basis of a table pre-determined by the social network administrator or alternatively by a logged-in user.

3. A method according to claim 1, where a further logged-in user, having met the publication conditions, updates the product request page automatically:
(a) by subscribing to the product request page at the maximum economical condition already present in said product request page or, alternatively;
(b) by subscribing to the product request page, but inserting a different maximum economical condition or, alternatively;
(c) by subscribing to the product request page at one of the maximum economical conditions already present in said product request page.

4. A method according to claim 3, where the update of said product request page includes the graphical representation of the total number of product requests for every maximum economical condition entered by at least one logged-in user.

5. A method according to claim 3, where the product request page includes the graphical representation of the minimum quantity of expected purchases for the product represented in the product request page for every maximum economical condition present in said product request page.

6. A method according to claim 5, where the minimum quantity of expected purchases for the product of the product request page for every maximum economical condition present in said product request page is determined on the basis of the following steps:
(a) calculating and recording the number of product requests that were followed (confirmed) by actual purchases for every previously logged-in user (number of individual confirmations);
(b) calculating and recording the number of product requests that were not previously followed (confirmed) by actual purchases for every logged-in user (number of individual denial);
(c) calculating and recording the estimated probability that every logged-in user confirms a generic product request (individual reliability) on the basis of the number of individual confirmations and the number of individual denials of every logged-in user;
(d) composing a cumulative probability on the basis of the individual reliabilities of those logged-in users who formed the total number of product requests for every maximum economical condition of the product request page.

7. A method according to claim 6, where the numbers of individual confirmations and individual denials are calculated and recorded on the basis of specific parameters determined by the social network administrator.

8. A method according to claim 7, where the parameters are estimated on the basis of the logistic regression model.

9. A method according to claim 1, where the publication conditions for every logged-in user are calculated as a function of the individual reliability of said logged-in user on the basis of a table pre-determined by the social network administrator.

10. A method according to claim 2, where a further logged-in user, having met the publication conditions, updates the product request page automatically:
(a) by subscribing to the product request page at the maximum economical condition already present in said product request page or, alternatively;
(b) by subscribing to the product request page, but inserting a different maximum economical condition or, alternatively;
(c) by subscribing to the product request page at one of the maximum economical conditions already present in said product request page.

11. A method according to claim 2, where the publication conditions for every logged-in user are calculated as a function of the individual reliability of said logged-in user on the basis of a table pre-determined by the social network administrator.

12. A method according to claim 3, where the publication conditions for every logged-in user are calculated as a function of the individual reliability of said logged-in user on the basis of a table pre-determined by the social network administrator.
